(19) United States
(12) Patent Application Publication
(10) Pub. No.: US 2014/0152047 A1
(43) Pub. Date: Jun. 5, 2014

(54) HINGED TRUCK ACCESSORY

(71) Applicant: Raymond H. Starman, Norfolk, NE (US)

(72) Inventor: Raymond H. Starman, Norfolk, NE (US)

(21) Appl. No.: 13/690,738

(22) Filed: Nov. 30, 2012

(51) Int. Cl. B60P 7/02

(52) U.S. Cl. CPC B60P 7/02
USPC 296/100.07

(57) ABSTRACT

The present invention is a hinged truck accessory that includes a top cover fitted over a pick-up truck bed to cover a plurality of contents placed in the pick-up truck bed, a frame that includes a plurality of bolts and a pair of angle irons, the frame is attached to the perimeter of the pick-up truck bed with the bolts and a plurality of hinges disposed on the first side edge of the top cover and on the first side of the frame. The hinged truck accessory also includes a sliding bar latch with a middle portion, the sliding bar latch is attached to the first end of the top cover and a handle attached to the middle portion of the sliding bar latch, the handle is utilized to swing open and close the top cover.

### TECHNICAL FIELD & BACKGROUND

Many pickup truck owners choose their vehicle because of the open-air rear cargo area that is used for storage and transporting objects and materials. During inclement weather such as rain or snow, a cover is used to protect the contents, though the area may only be reached through one entrance.

The present invention generally relates to a truck accessory. More specifically, the invention is a hinged truck accessory.

It is an object of the invention to provide a hinged truck accessory that provides a hinged covering to protect a bed of a pick-up truck.

It is an object of the invention to provide a hinged truck accessory that allows a user to relatively easy protected access to the bed of a pick-up truck from three sides.

What is needed is a hinged truck accessory that provides a hinged covering to protect a bed of a pick-up truck that allows a user to relatively easy protected access to the bed of a pick-up truck from three sides.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a back environmental view of a hinged truck accessory, according to an embodiment of the present invention.

FIG. 1B illustrates a back environmental view of a hinged truck accessory, according to an embodiment of the present invention.

FIG. 1C illustrates a back environmental view of a hinged truck accessory, according to an embodiment of the present invention.

FIG. 2 illustrates a back environmental view of a hinged truck accessory, according to an embodiment of the present invention.

FIG. 3 illustrates a front view of a hinged truck accessory, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

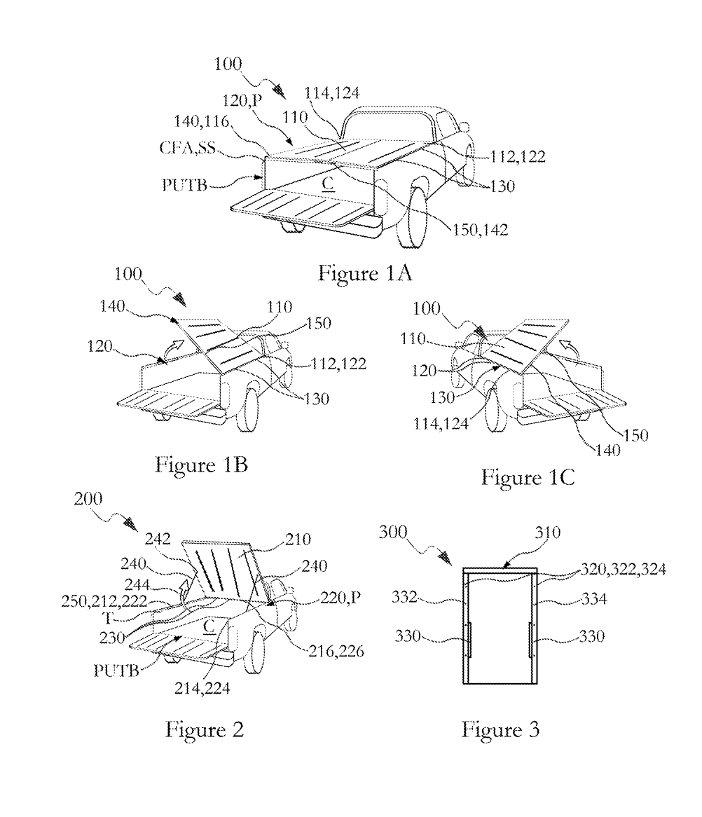

FIG. 1A illustrates a back environmental view of a hinged truck accessory 100, according to an embodiment of the present invention. The

The hinged truck accessory 100 includes a top cover 110, a frame 120, a plurality of hinges 130, a sliding bar latch 140 and a handle 150. The top cover 110 has a first side edge 112, a second side edge 114 and a first end 116. The top cover 110 is fitted over a pick-up truck bed PUTB to cover a plurality of contents C placed in the pick-up truck bed PUTB. The top cover 110 is made of relatively lightweight metal but can be made of other suitable material such as relatively durable lightweight plastic or carbon fiber. The frame 120 is attached to the perimeter P of the pick-up truck bed PUTB and supports the hinged truck accessory 100 and has a first side 122 and a second side 124. Additional details regarding the frame 120 are illustrated and described in FIG. 3 and its description. The hinges 130 are disposed on the first side edge 112 of the top cover 110 and on the first side 122 of the frame 120 and allow the top cover 110 to be swung open and closed. The hinges 130 illustrated in FIG. 1A include a pair of hinges 130, although any suitable number of hinges can be utilized. The sliding bar latch 140 has a middle portion 142 and is attached to the first end 116 of the top cover 110. The sliding bar latch 140 slides horizontally into a corresponding fitted aperture CFA disposed on a second side SS of the pick-up truck bed PUTB to releasably secure the top cover 110 over the frame 130 and the pick-up truck bed PUTB. The handle 150 is attached to the middle portion 142 of the sliding bar latch 140 and is utilized to swing open and close the top cover 110.

FIG. 1B illustrates a back environmental view of a hinged truck accessory 100, according to an embodiment of the present invention.

FIG. 1B includes a hinged truck accessory 100 with a top cover 110, a frame 120, a plurality of hinges 130, a sliding bar latch 140 and a handle 150 that is similar to a hinged truck accessory 100 with a top cover 110, a frame 120, a plurality of hinges 130, a sliding bar latch 140 and a handle 150 that is illustrated and described in FIG. 1A and its description. In contrast to FIG. 1A, which illustrates and describes a hinged truck accessory 100 in a closed position, FIG. 1B illustrates and describes a hinged truck accessory 100 swung open. Similar to FIG. 1A, the hinged truck accessory 100 illustrated and described in FIG. 1B, the hinges 120 are disposed on the first side edge 112 of the top cover 110 and on the first side 122 of the frame 120 and allow the top cover 110 to be swung open and closed.

FIG. 1C illustrates a back environmental view of a hinged truck accessory 100, according to an embodiment of the present invention.

FIG. 1C includes a hinged truck accessory 100 with a top cover 110, a frame 120, a plurality of hinges 130, a sliding bar latch 140 and a handle 150 that is similar to a hinged truck accessory 100 with a top cover 110, a frame 120, a plurality of hinges 130, a sliding bar latch 140 and a handle 150 that is illustrated and described in FIG. 1B and its description. Similar to FIG. 1B, FIG. 1C illustrates and describes a hinged truck accessory 100 swung open. In contrast to FIG. 1B, the hinged truck accessory 100 illustrated and described in FIG. 1C has the hinges 130 that are disposed on the second side edge 114 of the top cover 110 and on the second side 124 of the frame 120 and allow the top cover 110 to be swung open and closed.

FIG. 2 illustrates a back environmental view of a hinged truck accessory 200, according to an embodiment of the present invention.

The hinged truck accessory 200 includes a top cover 210, a frame 220, a plurality of hinges 230, a pair of hinged brace rods 240 and a pair of angle irons 250. The top cover 210 has a first side edge 212, a second side edge 214 and a first end 216. The top cover 210 is fitted over a top T of a pick-up truck bed PUTB to cover a plurality of contents C placed in the pick-up truck bed PUTB. The top cover 210 is made of relatively lightweight metal but can be made of other suitable material such as relatively durable lightweight plastic. The frame 220 is attached to the perimeter P of the pick-up truck bed PUTB and supports the hinged truck accessory 200 and has a first side 222, a second side 224 and a top side 226. Additional details regarding the frame 220 are illustrated and described in FIG. 3 and its description. The hinges 230 are attached to the first end 216 of the top cover 210 and the top side 226 of the frame 220. The pair of hinged brace rods 240 have a pair of first ends 242 and a pair of second ends 244. The first ends 242 of the pair of hinged brace rods 240 are attached to the first side edge 212 and the second side edge 214 of the top cover 210. The pair of hinged brace rods 240 facilitates opening and closing the top cover 210 over the pick-up truck bed PUTB. The pair of angle irons 250 are disposed on the first side edge 212 and the second side edge 214 of the top cover 210 and on the first side 222 and the second side 224 of the frame 220. The second ends 244 of the pair of hinged brace rods 240 are attached to the pair of angle irons 250 that are disposed on the first side 222 and the second side 224 of the frame 220. The pair of angle irons 250 is provided with 4 stops to secure the pair of hinged brace rods 240 and top cover 210 in four positions.

FIG. 3 illustrates a front view of a frame 310 of a hinged truck accessory 300, according to an embodiment of the present invention.

The frame 310 includes a plurality of bolts 320 and a pair of angle irons 330. The frame 310 and the pair of angle irons 330 illustrated and described in FIG. 3 are similar to the frame 210 and the pair of angle irons 250 illustrated and described in FIG. 2. The frame 310 is attached to the perimeter P of the pick-up truck bed PUTB and supports the hinged truck accessory 300. The frame 310 is approximately 1 inch in thickness by approximately 4½ inches in width, but can be any suitable dimensions. The frame 310 is also made of pine wood, oak wood or any other suitable material. The bolts 320 attach the frame 310 to the perimeter P of the pick-up truck bed PUTB. The bolts 320 are typically made of metal and any suitable fastener such as a plurality of screws 322 or a plurality of rivets 324 can be utilized to attach the frame 310 to the perimeter P of the pick-up truck bed PUTB. The pair of angle irons 330 is disposed on a first side 332 and a second side 334 of the frame 310.

The hinged truck accessory is a hinged accessory for pick-up trucks. The hinged truck accessory allows users to access the pick-up truck bed from the left, right or the rear of the pick-up truck. The frame of the hinged truck accessory is made of both oak wood and pine wood while the cover is a lightweight metal material. When open, steel brace rods for each open position ensures that the cover remains lifted, while a plurality of chains prevent it from being blown open by the wind. The hinged truck accessory may be readily available in a variety of sizes to accommodate a wide range of pickup trucks. The hinged truck accessory features a hinged encasement for pick-up trucks with access to the back and two sides. The hinged truck accessory is designed to have a pair of locks to ensure the pick-up truck bed of the pick-up truck is secured from theft.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A hinged truck accessory, comprising:
a frame having a first side and a second side, wherein the frame is permanently attached to the perimeter of a pick-up truck bed;
a rigid, planar top cover with a first side edge, a second side edge and a first end, wherein said top cover is sized to fit over a pick-up truck bed; and
a plurality of hinges, wherein each hinge is attached to the top cover and the frame, enabling the top cover to swing open and closed relative to the pick-up truck bed on which the frame is mounted.

2.-20. (canceled)
